(19) United States
(12) Patent Application Publication
(10) Pub. No.: US 2026/0102769 A1
(43) Pub. Date: Apr. 16, 2026

(54) Method for Microfluidic Device Operation

(71) Applicant: Standard BioTools Inc., South San Francisco, CA (US)

(72) Inventor: David John GUCKENBERGER, Jr., South San Francisco, CA (US)

(73) Assignee: Standard BioTools Inc., South San Francisco, CA (US)

(21) Appl. No.: 19/117,331

(22) PCT Filed: Oct. 16, 2023
(86) PCT No.: PCT/US2023/035212

§ 371 Date: Mar. 31, 2025

Related U.S. Application Data
(60) Provisional application No. 63/416,175, filed on Oct. 14, 2022.
(60) Provisional application No. 63/417,894, filed on Oct. 20, 2022.

(51) Int. Cl. B01L 3/00

(52) U.S. Cl. CPC B01L 3/50273; B01L 2200/0684; B01L 2400/0487; B01L 2400/0633

(57) ABSTRACT

Methods for preparing a microfluidic device for operation are presented. In some embodiments, an interface network is pressurized via a liquid to purge at least a portion of a gas present in the interface network while another portion of the gas remains trapped in at least one region of the interface network and is perfused at least partially into sample chambers. The sample chambers can be pressurized via a liquid to purge at least a portion of a gas present in the sample chambers while another portion of the gas remains trapped in at least one region of the sample chambers and is perfused at least partially into assay chambers. The assay chambers can be pressurized via a liquid to purge at least a portion of a gas present in the assay chambers into a containment network, which can be pressurized for at least partially purging the containment network.

### RELATED APPLICATIONS

This application claims priority to U.S. Provisional Application No. 63/416,175 filed on Oct. 14, 2022 and U.S. Provisional Application No. 63/417,894 filed on Oct. 20, 2022, the contents of both of which are incorporated herein in their entirety.

### TECHNICAL FIELD

The present disclosure relates generally to microfluidic device operation, and more particularly to methods for preparing a microfluidic device for use.

### BACKGROUND

Microfluidic devices are essential in performing many experiments in biological applications. It is therefore essential to devise efficient and fast ways of performing experiments using microfluidic devices.

### SUMMARY

Microfluidic devices can allow for thousands of reactions to be performed on a device, or chip, that can be held in your hand. However, preparing such devices for the introduction of samples and reagents can be difficult as surface tension and other properties of fluid (liquid and gas) that are largely unimportant at larger scales become dominant at the microfluidic scale.

The removal of air from a microfluidic device is of particular importance in preparing the device for use.

It was surprisingly found that the methods of the present teachings not only reduced the time it takes to prepare a microfluidic device by more than 50% but also dramatically reduced (by two orders of magnitude) the number of measurements adversely impacted by air bubbles. See further below where errors (combined false positives and negatives) were reduced from over 740 when using a conventional method to 4 using an embodiment of the present teachings.

Microfluidic devices typically have four general features, a network of channels for delivering samples to reaction regions, a network of channels for delivering reagents (e.g., assays) to the reaction regions, a means to prevent samples and reagents from mixing/interacting until desired, and a means to isolate two reaction regions from each other.

In the present application, the means to prevent samples and reagents from mixing/interacting until desired comprises a network of microfluidic channels to which pressure can be applied to effectuate valves, and the means to isolate two reaction regions from each other comprises a network of microfluidic channels to which pressure can be applied to effectuate valves.

In one aspect, in a microfluidic device formed from a gas-perfusable material having a plurality of discrete fluidic networks in communicable distance (i.e., a distance through which gas can perfuse between two adjacent networks) relative to one another, the networks comprising elements that can trap air during filling, a method for preparing said microfluidic device for operation is disclosed, which comprises sequentially performing the following steps: (a) pressurizing a first network via introduction of a liquid into the first network to a pressure greater than a pressure associated with a second network so as to purge a portion of a first gas out of the first network while another portion of the gas remains trapped in at least one region of the first network and is perfused at least partially into said second network, (b) introducing a second liquid into the second network in fluidic communication with a chamber from which measurements are made so as to pressurize a second gas in second network to a pressure greater than a pressure associated with a third network so as to purge a portion of the second gas out of the second network while another portion of the second gas remains trapped in least one region of the second network and is perfused at least partially into the third network, (c) introducing a third liquid into a third network to pressurize a third gas in the third network to a pressure greater than a pressure associated with a fourth network so as to purge a portion of the gas out of the third network while another portion of the third gas remains trapped in at least one region of the third network and is perfused at least partially into said fourth network, and (d) introducing a fourth liquid into the fourth network to purge the third gas out of the fourth network.

The first, the second and the third gas can be the same gas, e.g., air, or any two of the gases can be different. Further, the same liquid or different liquids can be employed for pressurizing the networks.

The networks can be connectable through closable interfaces/valves. In some embodiments, such interfaces/valves can be formed of elastomeric materials.

In some embodiments, a maximum thickness of the perfusable material between at least one of said networks and an adjacent network is less than a minimum thickness of the perfusable material extending from said at least one of said networks to an edge of a body of said microfluidic device.

Any of the first, second and third liquid can be an aqueous or an organic liquid. By way of example, and without limitation, the liquid can be any of water, alcohol, and/or oil, among others.

Further, any of the gases that are pressurized can be any of air, nitrogen, oxygen, carbon dioxide, argon, among others.

In some embodiments, the microfluidic device can include chambers, such as sample and assay chambers, for receiving samples and liquid assays (e.g., reagents needed to perform a particular assay). In some such embodiments, the discrete networks can control fluid communication between the chambers.

In some embodiments, the volume of the trapped gas within a purged network can be greater than the volume of the gas trapped in a subsequently-purged network, if any.

In some embodiments, at least one of the networks may be at least partially filled with a liquid prior to receiving a trapped gas, via perfusion, from an adjacent network that has been purged through pressurization. By way of example, the trapped gas received by the at least partially-filled network can flow as bubbles through the liquid in that network. In some embodiments, the gas received by said at least partially-filled network can push the liquid (or at least a portion thereof) out of the network.

In some embodiments, the pressure associated with any of said pressurized networks can be equal to, greater than, or less than atmospheric pressure.

### BRIEF DESCRIPTION OF DRAWINGS

The drawings are not necessarily to scale or exhaustive. Instead, emphasis is generally placed upon illustrating the principles of the embodiments described herein. The accompanying drawings, which are incorporated in this specification and constitute a part of it, illustrate several embodiments consistent with the disclosure. Together with the description, the drawings serve to explain the principles of the disclosure.

In the drawings:

FIGS. 1A, 1B, 2A, and 2B schematically depict a microfluidic device implemented in some embodiments of the present teachings.

FIG. 3 illustrates various steps in an operation of the microfluidic device and an example of time saving that can be achieved when utilizing embodiments of the present teachings.

FIG. 4 schematically illustrates trapping of air in chambers of a microfluidic device and purging of the air from the chambers.

FIGS. 5A-5C illustrate an example of a conventional method of purging various components of the microfluidic device.

FIGS. 6A-6C illustrate an example of a method of preparing a microfluidic device according to embodiments of the present teachings.

FIGS. 7A-7C illustrate pressure and temperature profiles of the microfluidic device according to embodiments of the present teachings.

FIG. 8 shows an example of improvement in error reduction due to air bubbles that can be obtained when using a microfluidic device prepared according to embodiments of the present technology.

FIG. 9 illustrates reference workflows for gene expression (GE) and genotyping (GT) runs implemented with a Standard BioTools 96.96 IFC microfluidic device, according to an experimental example in which a conventional (reference) loading method was applied and an experimental example in which a loading method according to embodiments of the present technology (express) was applied.

FIG. 10 illustrates examples of performing multiple GT and GE runs in an 8-hour working shift when using a loading method according to embodiments of the present technology (express).

FIG. 11 illustrates average instrument run times for different microfluidic devices and application types from validation studies using the Standard BioTools X9 genomics system.

FIG. 12 illustrates an experimental comparison of ΔΔCt values from identical Standard BioTools 96.96 IFC microfluidic devices run with human tissue cDNA samples and panel A of the Advanta IO gene expression panel using a conventional (reference) loading method and a loading method according to embodiments of the present technology (express).

FIG. 13 illustrates experimental results of gene expression uniformity tests run on a Standard BioTools 96.96 IFC microfluidic device using a conventional (reference) loading method and a loading method according to embodiments of the present technology (express).

FIG. 14A illustrates TaqMan genotyping performance of a Standard BioTools 96.96 IFC microfluidic device in an experiment using a conventional (reference) loading method.

FIG. 14B illustrates TaqMan genotyping performance of a Standard BioTools 96.96 IFC microfluidic device in an experiment using a loading method according to embodiments of the present technology (express).

FIGS. 15A and 15B include schematic illustrations and photographs, respectively, of studies assessing the impact of different levels of bubble formation in a Standard BioTools 96.96 IFC microfluidic device using a loading method according to embodiments of the present technology (express).

### DETAILED DESCRIPTION

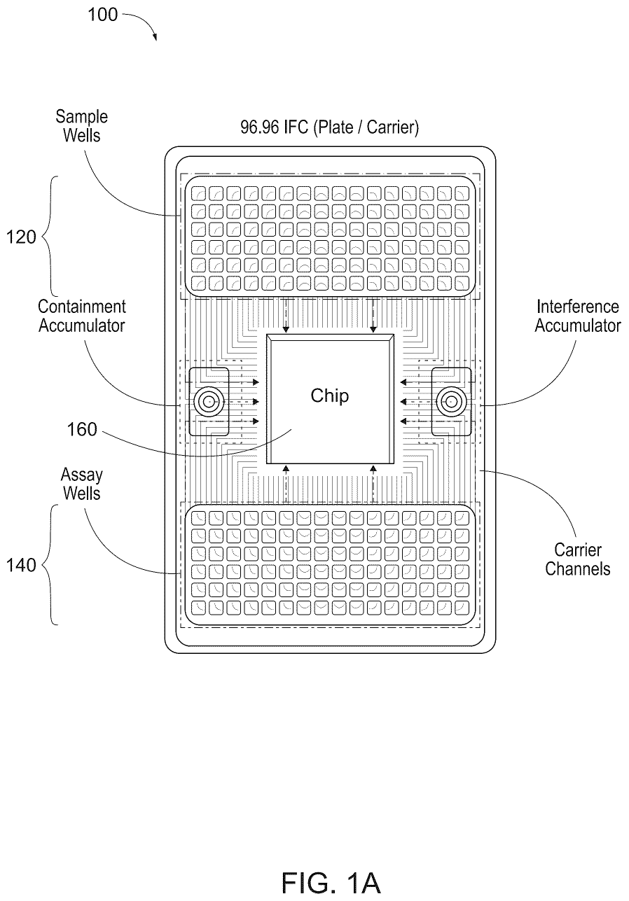

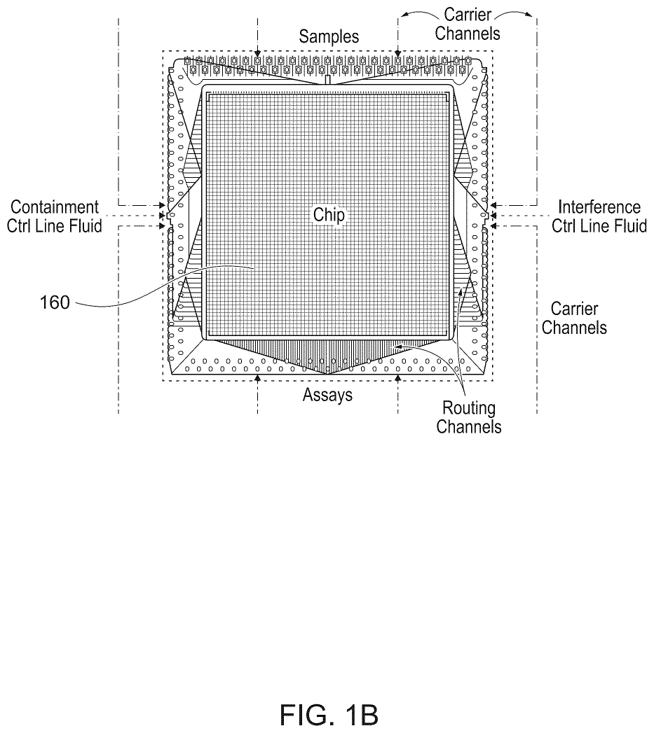

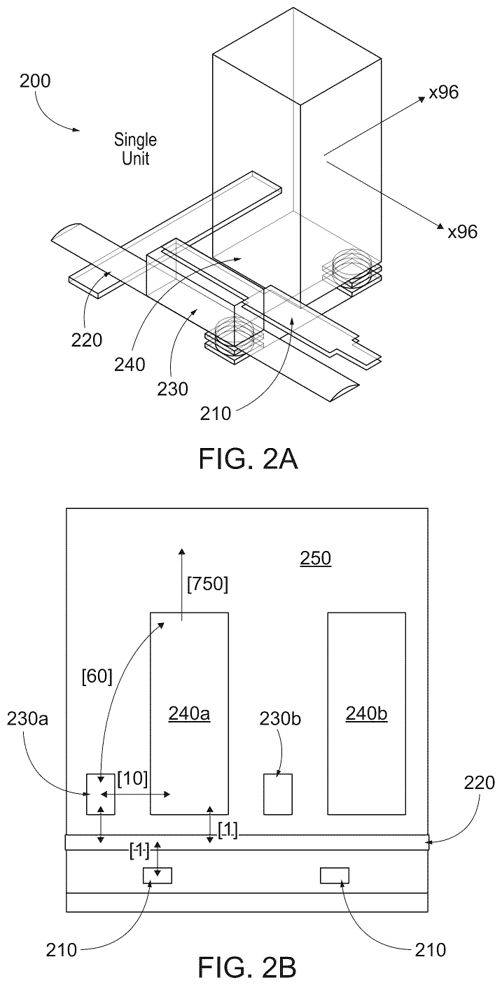

FIGS. 1A, 1B, 2A, and 2B schematically depict a microfluidic device 100 that includes two sets of wells 120 and 140 for samples and assays respectively. A sample analysis can be performed by delivering sample and assay liquids from the sample and assay wells via a network of microfluidic channels to, respectively, sample chambers 240 and assay chambers 230 formed within a fluidic manifold 160 and allowing the two liquids to mix via diffusion to perform a sample analysis. It is to be understood that FIGS. 1A, 1B, 2A and 2B are not necessarily to scale, emphasis instead being place on illustrating the present teachings.

FIGS. 2A and 2B schematically depict a portion of the fluidic manifold of the microfluidic device, where FIG. 2A three dimensionally illustrates a single unit 200 but it is to be understood that this unit is repeated. e.g., illustrated is repetition by 96×96 times for 9,216 single units in such a manifold and where, in this illustration the microfluidic device has 96 sample inputs 120 and 96 reagent inputs 140. FIG. 2B is a schematic cross section of the various microfluidic structures formed in a perfusable material 250, where the numbers in square brackets are relative distances through the perfusable material between the various structures. It is to be understood that the structures illustrated in FIGS. 2A and 2B are but a small portion of the structures in the fluidic manifold, e.g., the channels 210 and 220 are but a portion of the networks of which they are a part.

In this particular example, the sample chambers 240 in the fluidic manifold are taller (i.e., have a greater height) than the assay chambers 230. The term “height” as used herein refers to a dimension of a chamber orthogonal to a lower surface of the device. Tall here refers to the dimensions vertical with respect to the surface of the device. As illustrated in FIGS. 2A and 2B, a sample chamber 240 and assay chamber 230 occur in pairs; FIG. 2A showing a single pair 230, 240 and FIG. 2B two adjacent pairs 230a, 240a and 230b, 240b.

The fluidic manifold 160 (herein also referred to as “a chip manifold”) also provides fluidic connections as well as control of those fluidic connections between the sample chambers and the assay chambers.

More particularly, the fluidic manifold includes a network of channels for providing fluidic connections between the liquids in the sample and the assay chambers.

In addition, the fluidic manifold comprises an interface network including a plurality of microfluidic channels (control channels) 210 that can control fluid communication between the sample chambers 240 and the assay chambers 230, that is the interface network is used to prevent samples and reagents from mixing/interacting until desired. In particular, the interface network can be used in a closed state to isolate the assay chambers from the sample chambers. In an open state, the interface network can allow communication between the assay chambers and the sample chambers. In other words, the control channels of the interface network can operate as valves that, when closed, inhibit the passage of liquids between the sample chambers and assay chambers until a reaction is intended to be initiated, in which case the interface valves are changed from a closed state to an open state allowing fluid communication between a sample chamber and its paired assay chamber, e.g., via the diffusion of the sample and assay liquids.

In addition, the fluidic manifold can include a containment network including a plurality of control channels 220 that can be used, when in a closed state, to isolate each sample chamber and assay chamber pair from fluid communication with another from other such pairs, e.g., to isolate two reaction regions from each other where here the reaction region is the combined sample and assay chamber pair when the associate interface network control channel is in an open state.

More specifically, the control channels 220 of the containment network can operate as valves that, when closed, can inhibit the passage of liquid from a first pair of sample-assay wells (e.g., 230a, 240a) to second (and possibly adjacent) pair of sample-assay wells (e.g., 230b, 240b), thereby isolating the reaction in each pair from other pairs.

The valves, in this example, are made from thin and flexible layers of polydimethylsiloxane (PDMS) to allow actuation thereof through back pressure into an open or closed state; the perfusable material 250 in this example also comprises PDMS.

Further details regarding examples of the above microfluidic device can be obtained by reference to U.S. Pat. Nos. 8,220,487, 8,163,492, and 9,643,178, each of which is herein incorporated by reference in its entirety.

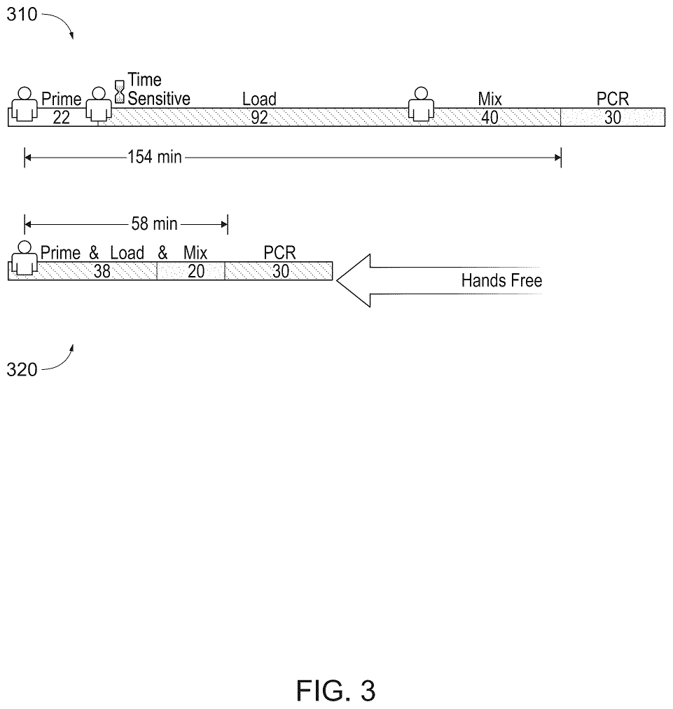

FIG. 3 is an illustration of various steps in a typical operation of the microfluidic device 100 and shows an example of time saving that can be achieved when utilizing various embodiments of the present teachings for preparing the microfluidic device for operation relative to a conventional way of preparing the device. In FIG. 3 the human icon represents a step in the workflow where manual intervention occurs. The numbers in the bar graphs are times in minutes and do not include any time taken for manual intervention. A conventional workflow 310 is illustrated that uses the substantially separate and sequential steps (e.g., all priming steps are completed before any loading steps) of prime, load, and mix in preparation for interaction of the sample and assay for subsequent analysis (here PCR (polymerase chain reaction) is illustrated). This conventional workflow is compared to an embodiment of the present inventions 320 where the prime and load steps are intermingled (e.g., a loading step may be performed before all priming steps are complete and vice versa). The significant time savings in preparing the microfluidic device for experiments is illustrated, where the time to prime, load and mix is reduced from 154 minutes to 58 minutes.

In some embodiments, in addition to a change in the order in which a microfluidic device is purged, an increase in applied pressure relative to conventional methods may also be beneficial in reducing the time required for preparing the microfluidic device for use. For example, in some conventional methods, the assay chambers are pressurized and the sample chambers are de-pressurized prior to closing the containment valves. In contrast, in various embodiments of the present inventions, both the assay chambers and the sample chambers are pressurized, for example, to substantially the same pressure, prior to closing the containment valves.

It should be noted that the time savings illustrated in FIG. 3 are achieved even if the manual interventions in the conventional approach between prime and load and load and mix are eliminated.

In this example, a prime step includes purging the control channels (e.g., FIGS. 2A, 2B elements 210, 220) of the microfluidic device via pressurizing them with a liquid. By way of example, the microfluidic device can include an interface network (e.g., FIGS. 2A, 2B element 210) including control channels for controlling fluid communication between sample chambers and assay chambers and a containment network (e.g., FIGS. 2A, 2B element 220) for controlling fluid communication between pairs of sample and assay chambers that are in fluid communication during the mixing phase from adjacent pairs.

The loading step refers to the delivery of sample and assay liquids to the sample and assay chambers in preparation for the mixing step in which the sample and assay liquids in pairs of sample and assay chambers are mixed to perform a sample analysis (e.g., react a sample with the reagents of the assay), such as PCR.

In preparing a microfluidic device for introduction of samples and reagents for subsequent mixing and analysis it is important to ensure that the air is purged from the microfluidic device prior to initiation of sample analysis, as air bubbles trapped in the sample and/or assay chambers can adversely affect the analysis accuracy, e.g., producing false positives, false negatives and wasting sample and reagents as the data from such reaction regions cannot be used and the reaction may need to repeated with new samples and reagents.

The present inventions in various aspects and embodiments not only can decrease the time needed to prepare a microfluidic device relative to conventional methods (e.g., as illustrated in FIG. 3 and further below) but also reduce the occurrence of air bubbles.

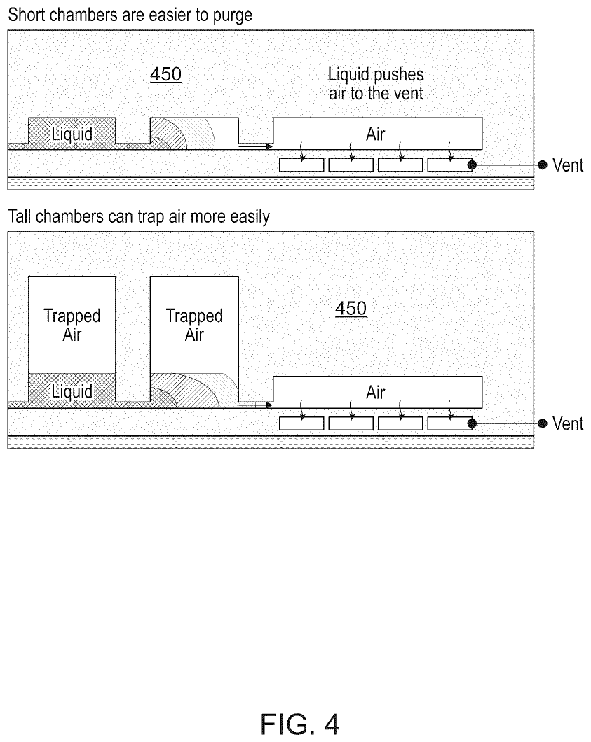

In this example, the removal of the air present in the taller chambers, namely, the sample chambers in this example, is more challenging than the removal of the air present in the shorter chambers, namely, the assay chambers in this example. Such trapping of the air in the chambers is schematically illustrated in FIG. 4 for structures formed in a perfusable material 450.

It is to be understood though that the methods of the present inventions are not limited to geometric shapes differences that are tall versus short, but can be applied geometric shapes that differ sufficiently in volume, e.g., large versus small, as on the microfluidic scale surface tension forces can dominate over the movement of gas via buoyancy.

As seen in the FIG. 4, the air trapped in shorter chambers can be much easier to purge through the back pressure of the liquid or through percolating of the air into vents shown in the figure. However, in the case of taller chambers, like the sample chambers in this example, the air can be trapped and thus be forced under pressure into the perfusable material 450. For example, this can be due to the fact that the only channel available for removing air trapped in the top of the taller chambers may be the bulk body of the microfluidic device (e.g., PDMS) 450 rather than through thinner layers connected to vents that could be available earlier in the purge sequence, that is before all the channels and chambers are filled with liquid.

In addition, the purging of a significant amount of air through the body of the microfluidic device may result in the air being dissolved in the body (e.g., in the PDMS), which can lead to formation of bubbles in the chambers as the air trapped in the body finds its way back into the chambers. This problem is compounded the higher the pressure used.

Accordingly, in conventional methods the chambers from which measurements of a sample-reagent reaction are made (e.g., via fluorescence) are purged of air last because it is in these portions where air bubbles are most detrimental to the analysis (i.e., most likely to produce errors/false results). In the example microfluidic device used for illustration here, the portion from which a measurement is made are the sample chambers (e.g., FIGS. 2A, 2B element 240).

It is to be understood that although the sample chamber is chamber from which measurements are made and the larger chamber, in various embodiments the methods are applicable in general to configurations where the measurement chamber is not also a sample chamber.

According to some embodiments of the present teachings, the order of the conventional operation of the microfluidic device is altered in a way that counterintuitively allows a more efficient purging of the device, e.g., by not purging the larger chamber from which measurements are made (the sample chamber in these examples) last but much earlier in the device preparation process.

It was surprisingly found that the methods of the present teachings not only reduced the time it takes to prepare the microfluidic device by more than 50% but also dramatically reduced (by two orders of magnitude) the number of measurements adversely impacted by air bubbles. See further below where errors (combined false positives and negatives) were reduced from over 740 when using a conventional method to 4 using an embodiment of the present teachings.

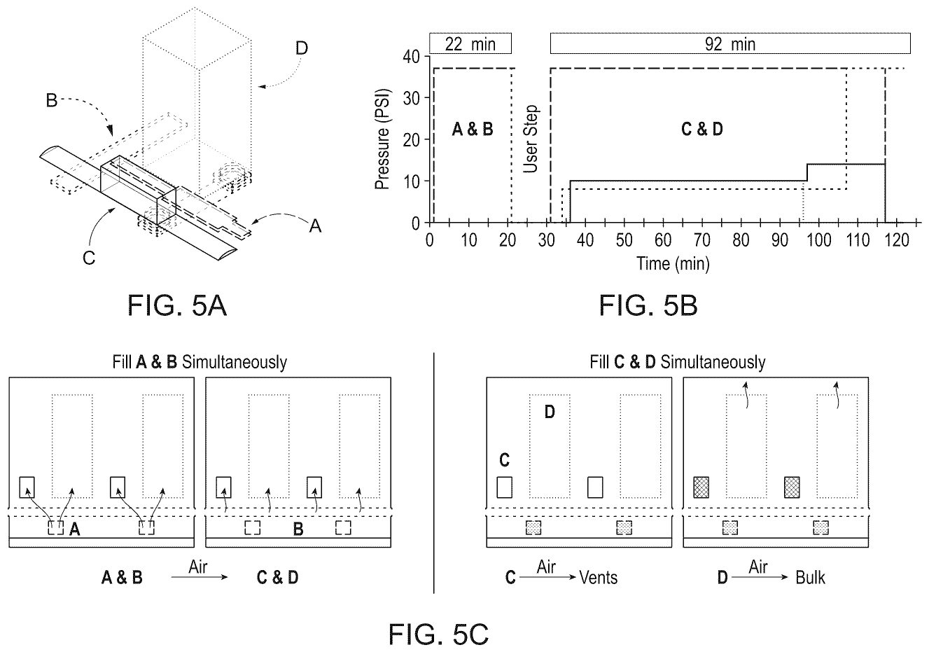

FIGS. 5A, 5B and 5C provide an illustration of an example of a conventional method of purging various components of the microfluidic device in which initially, the control channels of an interface network (A) and the control channels of a containment network (B) are purged, e.g., via pressurization of those channels with a liquid. Subsequently, the assay chambers (C) and the sample chambers (D) are purged via introduction of liquid assays (i.e., reagents needed for performing an assay) and samples into the assay and sample chambers respectively.

The traces in FIG. 5B are line-pattern coded to the structures illustrated in FG. 5A, where the long-dashed line trace is the pressure as a function of time in the interface network (A), the short-dashed line trace that in the containment network (B), the solid line trace that in the assay chambers (C), and the dotted line trace that in the sample chambers (D), FIG. 5C schematically illustrates the sequence with arrows illustrating the purging of air from a structure.

In such a conventional method of purging the microfluidic device, the purged air dissolved in the bulk PDMS can find its way back into the sample or assay chambers. Thus, it was believed that purging the sample chamber (D) last was necessary to reduce the prevalence of air outgassing from the perfusable material (bulk PDMS) back into the sample chamber.

In contrast, in various embodiments of the present teachings, instead of sequentially or simultaneously filling all the control networks (A & B) prior to purging the sample and assay chambers (C & D), the containment network (B) is not purged until the assay (C) and the sample chambers (D) are purged.

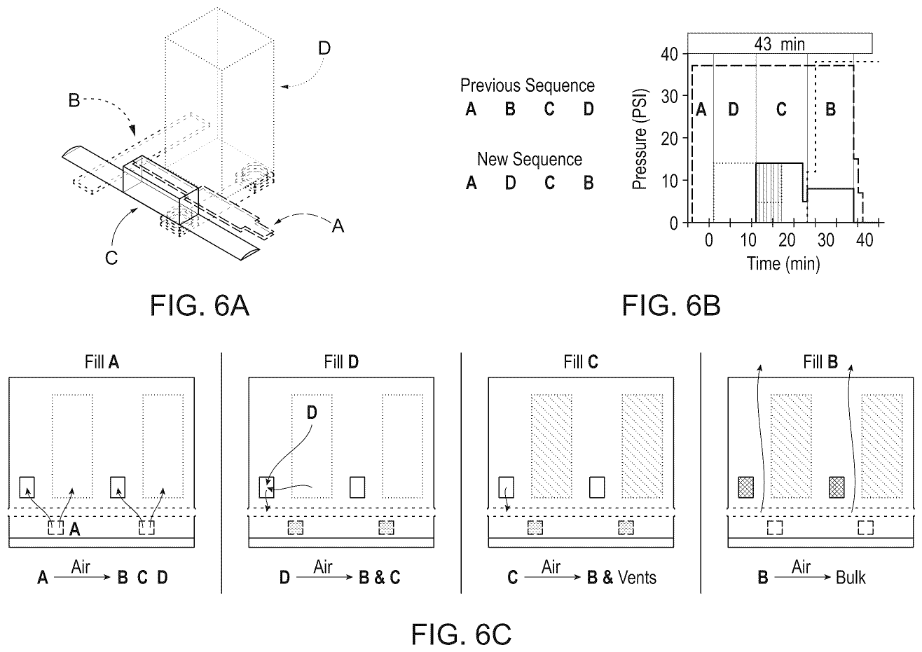

FIGS. 6A, 6B and 6C provide an illustration of an example of a method of preparing a microfluidic device according to various embodiments of the present inventions. In various embodiments, the order of operations comprises first purging the interface network (A), then purging the sample chambers (D), followed by purging the assay chambers (C), and lastly purging the containment network (B); where purging is provided, e.g., via pressurization of the respective channel with a liquid.

The traces in FIG. 6B are line-pattern coded to the structures illustrated in FG. 6A, where the long-dashed line trace is the pressure as a function of time in the interface network (A), the short-dashed line trace that in the containment network (B), the solid line trace that in the assay chambers (C), and the dotted line trace that in the sample chambers (D), FIG. 6C schematically illustrates the sequence with arrows illustrating the purging of air from a structure.

In this example, the control channels of the interface network (A) are initially pressurized via introduction of a liquid to a pressure greater than a pressure associated with sample (D) and assay (C) chambers as well as the containment network (B) so as to purge a portion of the air (or other gas) present in the interface network (A). Due to the differential pressure, the air trapped in the interface network (or at least a portion thereof) is received via perfusion through thin layers of PDMS by the assay (C) and sample (D) chambers as well as the containment network.

Subsequently, the sample chambers (D) are filled with a liquid sample, which results in pressurizing those chambers and hence purging the chambers of the air present therein. A differential pressure between the sample chambers (D) and the assay chambers (C) facilitates the perfusion of air trapped in the sample chambers (D) into the assay chambers (C) and the containment network (B)

Subsequently, the assay chambers (C) are filled with a liquid (e.g., assay reagents), which results in pressurizing the assay chamber (C) and hence purging the chamber of the air present therein. A differential pressure between the assay chambers (C) and the containment network (B) facilitates the perfusion of the air trapped, if any, in the assay chambers to the containment network (B).

Finally, the containment network (B) is pressurized via introduction of a liquid into the channels of the containment network (B), which causes the air within the containment network (B) to be purged via perfusion into the bulk of the microfluidic body and venting openings (not shown) with which the containment network (B) is in communication.

Following the purging of the microfluidic device, the control channels of the interface network can be transitioned into an open state to allow fluid communication between the sample chambers and the assay chambers and the control channels of the containment network are transitioned from an open state to a closed state to isolate pairs of sample/assay chambers that are in fluid communication. The fluid communication between the sample and assay chambers of a pair results in mixing of the sample and the assay liquid via diffusion.

It is to be understood that the examples illustrated in FIGS. 5A-5C and FIGS. 6A-6C were performed using microfluidic devices with the same structure (specifically a Standard BioTools 96.96 IFC microfluidic device). In addition, it should be noted that the “Fill A&B” step in FIGS. 5A-5C was conducted at 25° C., and the liquid (an oil) used in the “Fill A” step was heated to about 70° C. to reduce the fluid viscosity; however, the benefits of decreased preparation time and reduced air bubbles was also observed for embodiments where the liquid was not so heated in the “Fill A” step.

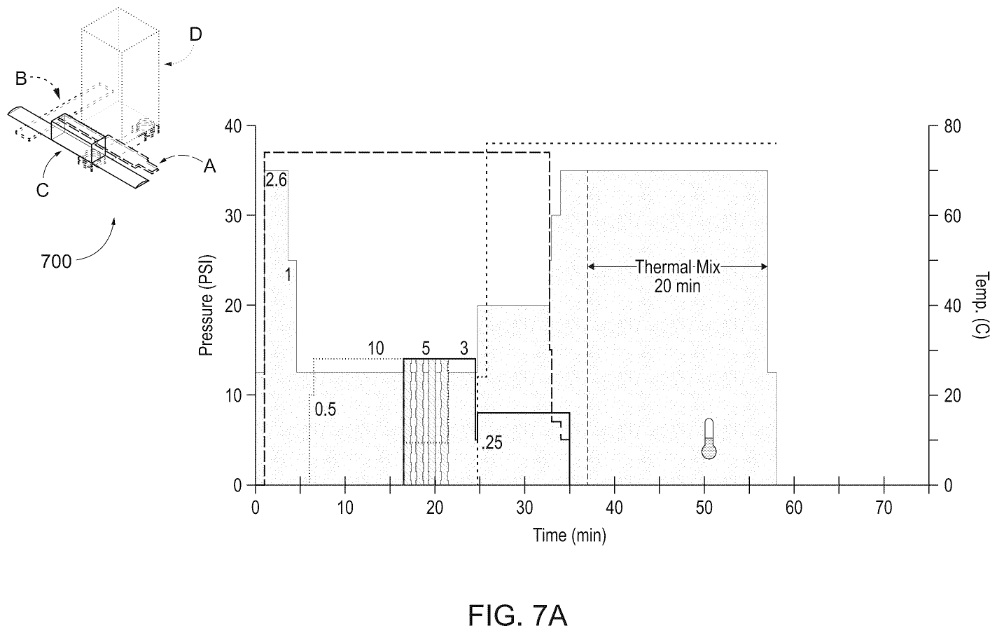

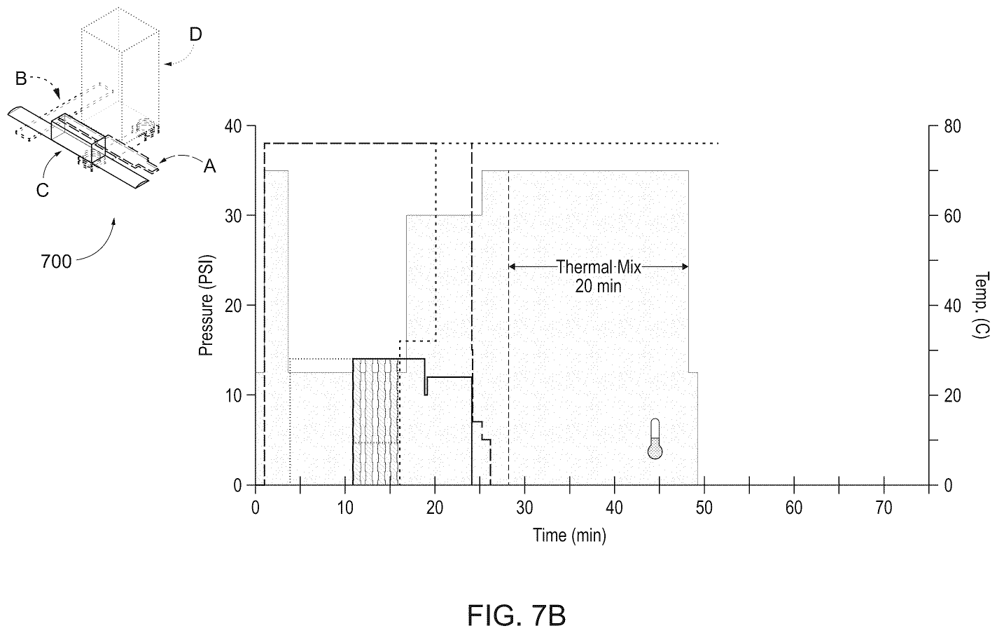

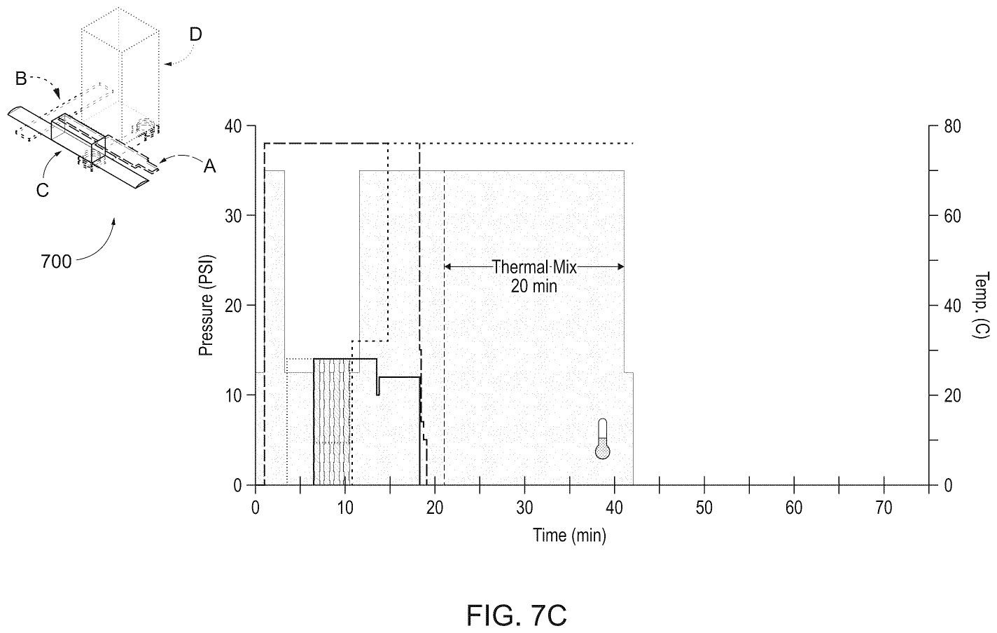

In some embodiments, modulation of the temperature of the microfluidic device can be employed to facilitate the preparation of the device. For example, the microfluidic device can be heated to lower the viscosity of certain liquid within the control channels of the interface and the containment networks to expedite the closing and opening of those channels. Further, the heating of the microfluidic device can be employed to facilitate mixing of the sample and assay liquids. Illustrative examples of pressure and temperature profiles according to various embodiments are shown in FIGS. 7A-7C, where the temperature profile corresponds to the shaded area and the pressure profile to the traces.

The schematic inset 700 is for ease of reference to align the line-pattern coded pressure traces, where the long-dashed line trace is the pressure as a function of time in the interface network (A), the short-dashed line trace that in the containment network (B), the solid line trace that in the assay chambers (C), and the dotted line trace that in the sample chambers (D).

The region “thermal mix” in FIGS. 7A-7C refers to an allocated amount time for mixing, via diffusion, to occur between the sample and assay chambers. During this time period, the interface between the sample and assay chambers is open, thus sample and assay are in fluidic communication. Temperature is often elevated to increase diffusion rates and reduce the amount of time needed to reach equilibrium between the sample and assay chambers. This is a procedure also performed in conventional methods.

FIG. 7A illustrates an embodiment where preparation time was reduced to about 57 min. using a Standard BioTools 96.96 IFC microfluidic device where 24 sample wells (e.g., FIG. 1 item 120) and 24 assay wells (e.g., FIG. 1 item 140) were empty. The numbers within the field of the graph of FIG. 7A provide more detailed time durations for various elements therein.

FIG. 7B illustrates an embodiment where preparation time was reduced to about 49 min. using a Standard BioTools 96.96 IFC microfluidic device where 24 sample wells (e.g., FIG. 1 item 120) and 24 assay wells (e.g., FIG. 1 item 140) were empty.

FIG. 7C illustrates an embodiment where preparation time was reduced to about 42 min. using a Standard BioTools 96.96 IFC microfluidic device where all sample wells (e.g., FIG. 1 item 120) and assay wells (e.g., FIG. 1 item 140) were filled with liquid, i.e., all were filled either with a sample or assay reagent(s) respectively.

A method according to various embodiments of the present inventions can provide a number of advantages. For example, it can significantly reduce the device preparation time as well as reduced the presence of air bubbles in the sample and/or assay chambers during analysis. This can in turn enhance the accuracy of sample analysis, e.g., by reducing false positive and false negative results, as well as reduce waste of sample and reagents.

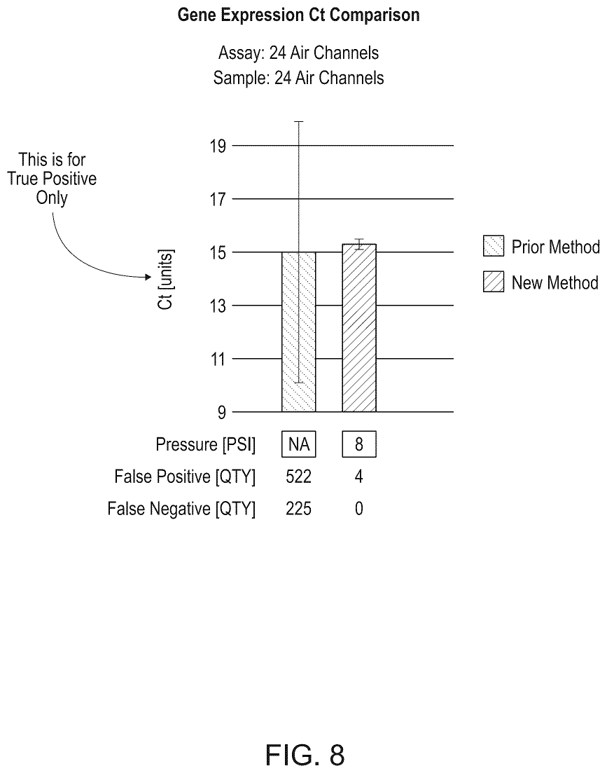

FIG. 8 shows an example of improvement in error reduction due to air bubbles that can be obtained when using a microfluidic device prepared according to various embodiments of the present inventions, such as the above microfluidic device 100, that is prepared in accordance with an embodiment of the present inventions for gene expression analysis. FIG. 8 compares the incidence of false negatives and false positives in a gene expression analysis using a Standard BioTools 96.96 IFC microfluidic device where 24 sample wells (e.g., FIG. 1 item 120) and 24 assay wells (e.g., FIG. 1 item 140) were empty. The false negatives and positives can be generally traced to air bubbles. In the new method illustrated in FIG. 8, the errors may not be due to air bubbles, rather it is believed that they may be due to potential leakage between sample chambers.

Using a conventional preparation method (prior method) 522 false positives and 224 false negatives were observed, for a total of 746 errors. In comparison, using the preparation method substantially according to that illustrated in FIG. 7A, only 4 false positives and no false negatives were observed; a factor of 186 (or over two orders magnitude) reduction in errors due to air bubbles.

Further understanding of various aspects of the present teachings may be obtained by reference to the following discussion of Experimental Results.

### Experimental Results

As can be understood in view if the experimental results that follow, the methods disclosed herein provide loading methods for integrated fluidic circuits (IFCs) that improve the turnaround time of applications run on the IFCs, in particular Standard BioTools 96.96 genotyping (GT)/gene expression (GE) IFC microfluidic devices. Moreover, as described below in greater detail, the experimental loading methods described in this section do not alter the IFC design, do not require additional consumables and labor, and do not adversely impact data quality.

Conventional loading methods for an IFC microfluidic device include the following steps:
Step 1—Load interface and containment control lines simultaneously (Prime).
Step 2—Load samples and assays simultaneously (Load/Mix).

In experimental express loading methods according to various embodiments of the present teachings, the filling/loading sequence of the IFC microfluidic device has been re-ordered as described in the foregoing detailed description to improve how air was evacuated from the chip.

In this example, heat was applied to reduce the viscosity of fluids, which enabled faster filling. Samples and assays were loaded at room temperature (low heat exposure). As compared with conventional loading methods, higher pressure was employed to reduce the impact of bubbles in the liquid network. More specifically, in contrast to conventional loading methods, the experimental express loading methods utilized in this example included the following steps:
Step 1—Load interface control line.
Step 2—Load samples.
Step 3—Load assays.
Step 4—Load containment control line.

In the experimental express loading methods, no separate prime step was employed. Control line fluid was loaded into the accumulators at the same time as the samples and assays were pipetted into the inlets.

The experimental express loading methods were implemented with the same, existing sample assay reagents, volumes, and preparation procedures used with Standard BioTools 96.96 IFC microfluidic devices. Sample and assay mix preparation for the experimental express loading methods were identical to the existing sample and assay mix preparation for Standard BioTools 96.96 IFC microfluidic devices. Additionally, the IFCs used for the experimental express loading methods were the same (same barcodes) as the existing Standard BioTools 96.96 IFCs.

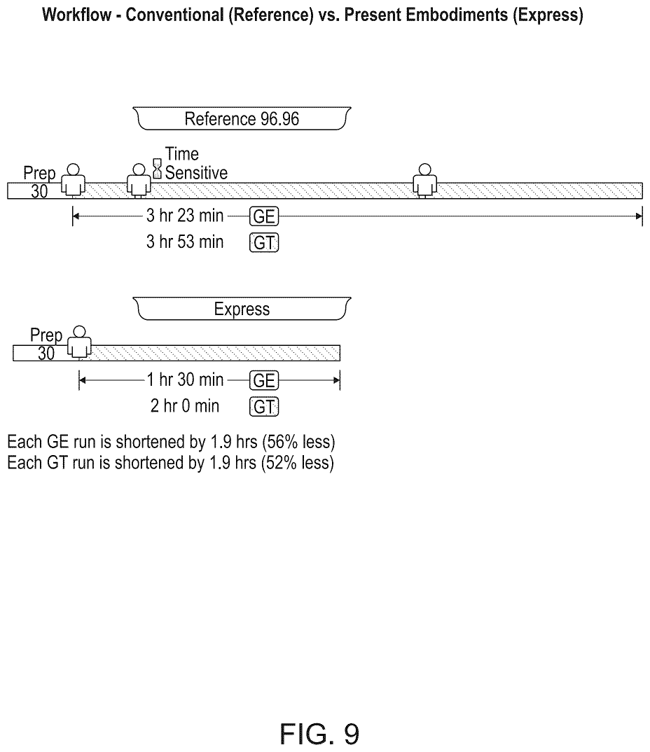

FIG. 9 illustrates reference workflows for gene expression (GE) and genotyping (GT) runs implemented with a Standard BioTools 96.96 IFC microfluidic device, according to an experimental example in which a conventional (reference) loading method was applied and an experimental example in which a loading method according to embodiments of the present technology (express) was applied. As can be appreciated from the illustration in FIG. 9, the GE and GT runs for the present express loading method were each 1.9 hours shorter than the GE and GT runs for the reference loading method. Thus, the GE run for the present express loading method was 56% shorter than the GE run for the reference loading method, and the GT run for the present express loading method was 52% shorter than the GT run for the reference loading method. Thus, the experimental example of FIG. 9 indicates that data can be obtained using the present express loading method in approximately half of the time required to obtain data using the reference script, though in other embodiments the loading time may be even shorter.

Additionally, FIG. 9 illustrates that the present express loading method eliminates some time-sensitive user interventions (e.g., between priming and loading/mixing operations), which allows laboratory staff to focus on other tasks.

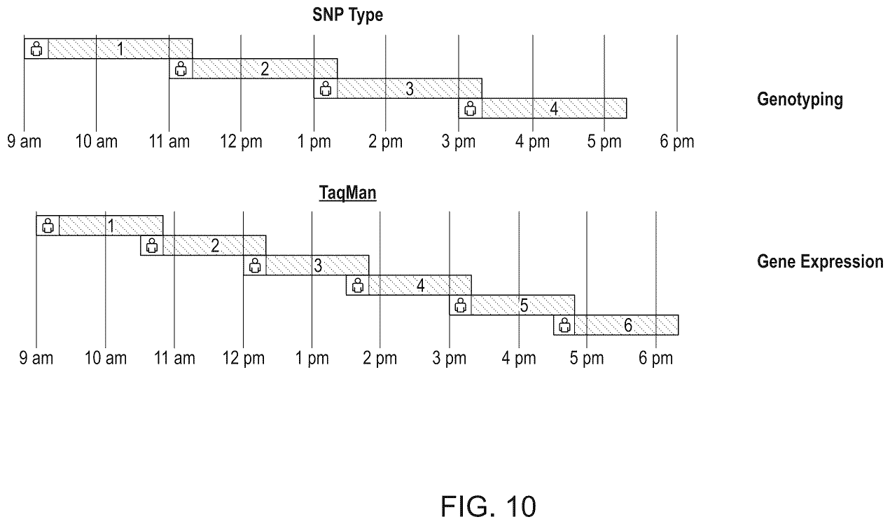

FIG. 10 illustrates examples of performing multiple GT and GE runs in an 8-hour working shift when using a loading method according to embodiments of the present technology (express). As illustrated in FIG. 10, the express loading method can support up to 4 GT runs or 6 GE runs in one 8-hour working shift, whereas the reference loading method can only support up to 2 GT runs or 2 GE runs in one 8-hour working shift. Thus, in comparison with the reference loading method, the express loading method can increase daily GT run capacity by up to 200% (192 more samples per day) and can increase daily GE run capacity by up to 300% (384 more samples per day).

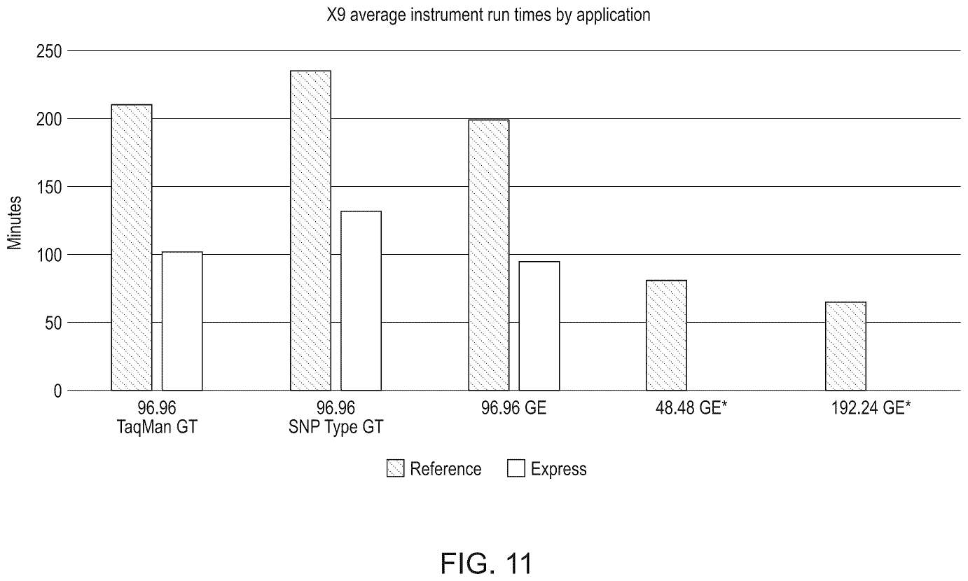

FIG. 11 illustrates average instrument run times for different microfluidic devices and application types from validation studies using the Standard BioTools X9 genomics system. It can be appreciated from FIG. 11 that, in implementations on Standard BioTools 96.96 IFC microfluidic devices, GE, SNP type GT, and TaqMan GT run times for the express loading methods according to the present teachings are substantially shorter (by approximately 50% or more) than the corresponding run times for the reference script.

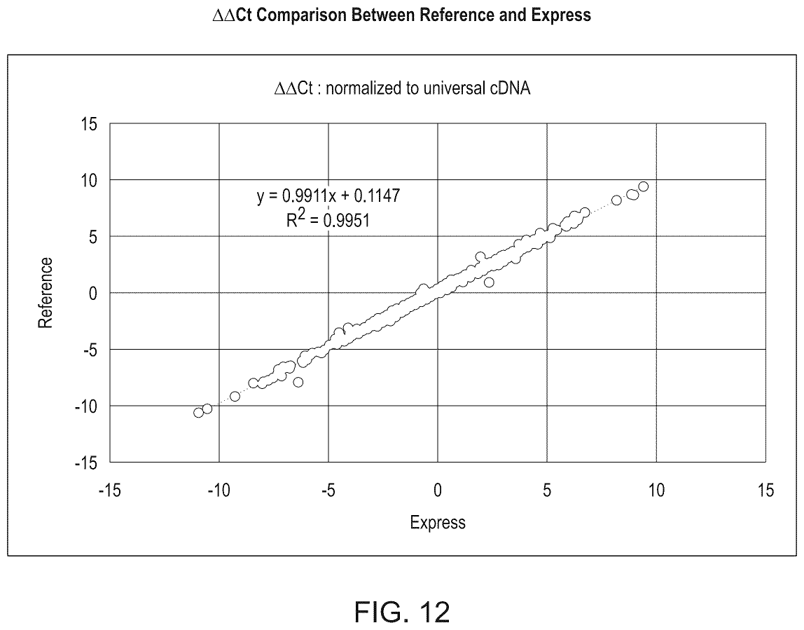

FIG. 12 illustrates an experimental comparison of ΔΔCt values from identical Standard BioTools 96.96 IFC microfluidic devices run with human tissue cDNA samples and panel A of the Advanta IO gene expression panel using a conventional (reference) loading method and a loading method according to embodiments of the present technology (express). In this example, the ΔΔCt values were calculated from three replicates of each sample using the 5 included reference targets for normalization. It can be seen that the correlation, slope, and intercept of the comparison plot in FIG. 12 demonstrate that the reference and express loading methods provide nearly identical gene expression results.

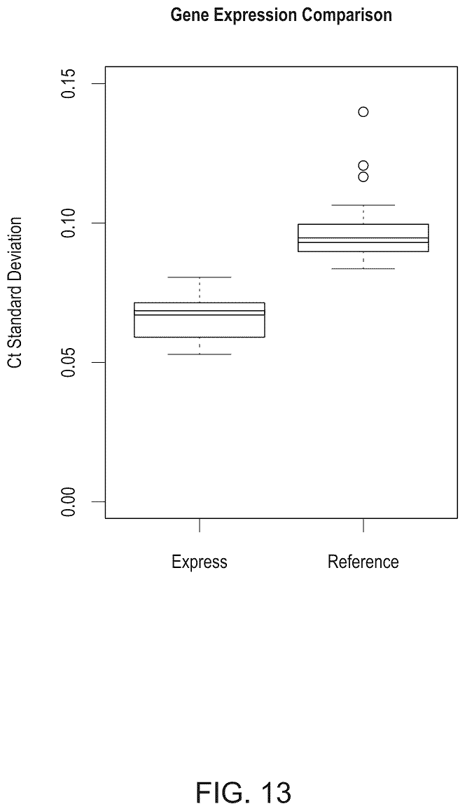

FIG. 13 illustrates experimental results of gene expression uniformity tests run on a Standard BioTools 96.96 IFC microfluidic device using a conventional (reference) loading method and a loading method according to embodiments of the present technology (express). In the test of FIG. 13, a single sample and a single assay were loaded across the IFC.

Ideally, in a gene expression uniformity test, all chambers of the IFC should give the same Ct result, and Ct standard deviation of all chambers can be used as a measure of Ct uniformity across the IFC. As shown in FIG. 13, in the uniformity test conducted for the present example, the express loading method exhibited a lower overall Ct standard deviation (mean=0.067, n=18) than the Ct standard deviation of the reference loading method (mean=0.090, n=18). This difference is statistically significant with a t-test for difference of means having a p-value of 7.3e-09. Thus, as indicated in FIG. 13, the express loading method produced better uniformity across the IFC in comparison with the reference loading method.

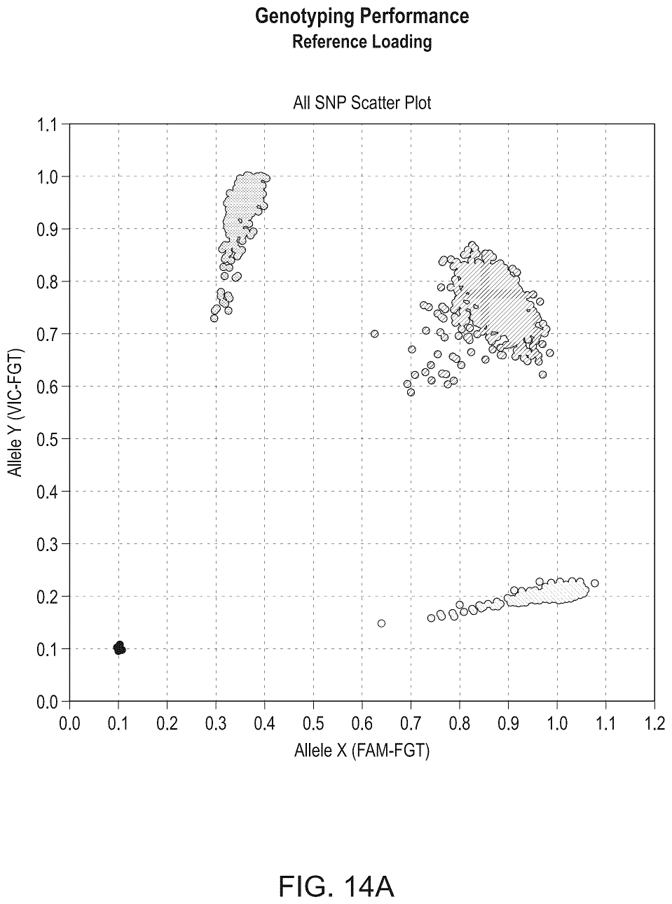

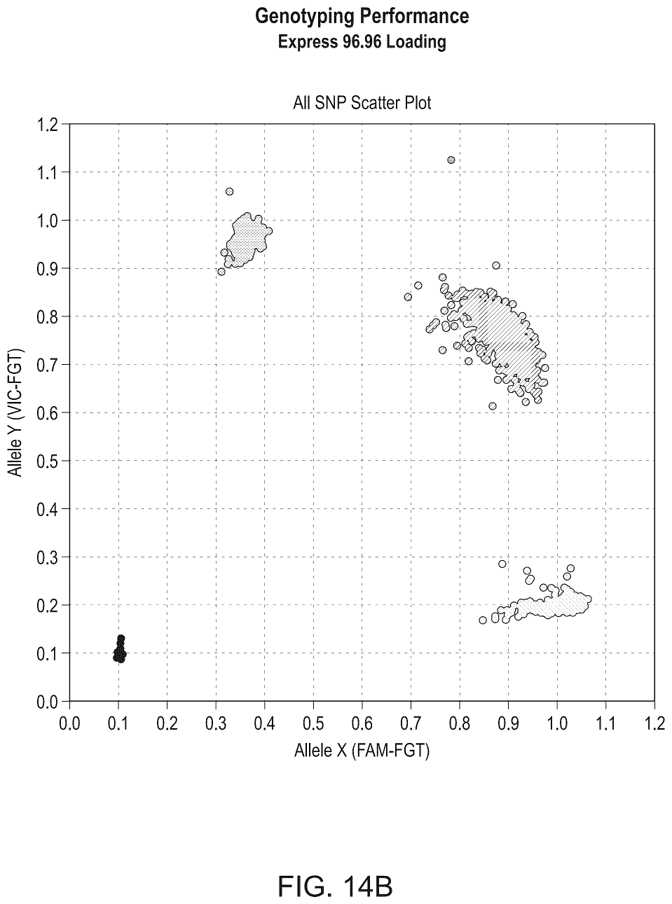

FIG. 14A illustrates TaqMan genotyping performance of a Standard BioTools 96.96 IFC microfluidic device in an experiment using a conventional (reference) loading method. FIG. 14B illustrates TaqMan genotyping performance of a Standard BioTools 96.96 IFC microfluidic device in an experiment using a loading method according to embodiments of the present technology (express). FIGS. 14A and 14B illustrate that the express loading method and the reference loading method generated similar genotyping cluster distributions.

In another example, Table 1 below shows a comparison of known genotyping results for IFCs that were run using the reference script and the express script, respectively, with TaqMan GT assays. In this example, identical IFCs were run using 92 samples (+4 NTCs) vs. 96 assays. Known genotypes for all assayed SNPs were obtained from publicly available sequencing and/or array data. Results of each IFC were compared to the known genotype for each sample/assay to determine concordance of each loading method with the known genotype.

TABLE 1

| | | Total | Concordant | Discordant | No | % | % |
|---|---|---|---|---|---|---|---|
| Comparison | Instrument | Calls | Calls | Calls | Call | Call | Concordant |
| Reference | X24 | 8825 | 8825 | 0 | 7 | 99.92% | 100% |
| Express | X24 | 8830 | 8827 | 3 | 2 | 99.95% | 99.93% |

As shown in Table 1 above, both loading methods generated similar concordance rates (>99%) for TaqMan GT.

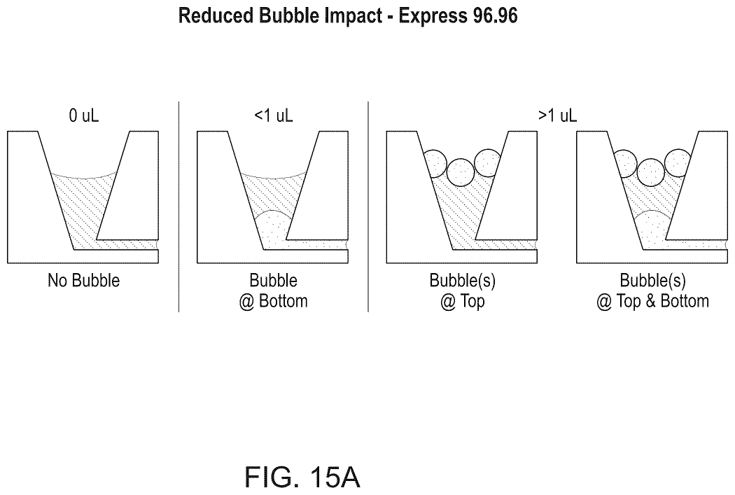

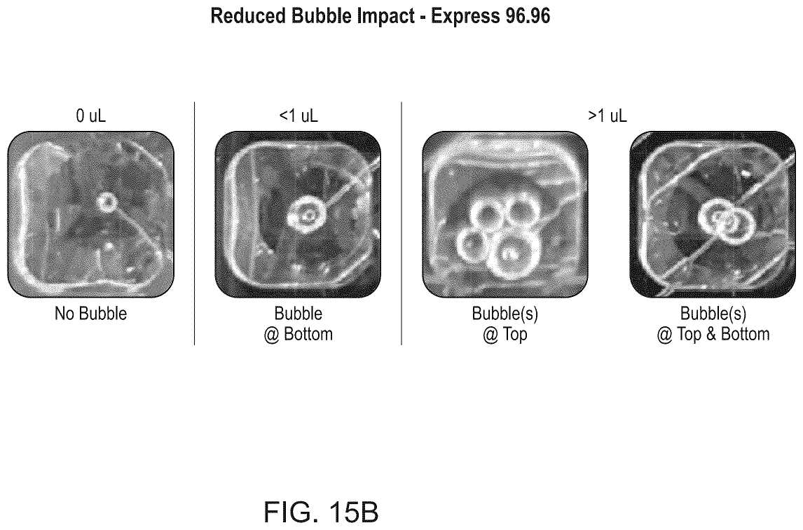

FIGS. 15A and 15B include schematic illustrations and photographs, respectively, of studies assessing the impact of different levels (e.g., size and location) of bubble formation in a Standard BioTools 96.96 IFC microfluidic device using a loading method according to embodiments of the present technology (express). More specifically, the study of FIGS. 15A and 15B evaluated the types of problematic bubble formation that can occur at reagent chambers/inlets by injecting various amounts of air into a reagent inlet. When no air (0 μL) was injected into the reagent inlet, no bubbles were formed in the reagent chamber, and both the reference loading method and the express loading method of an embodiment of the present invention filled the device well. When less than 1 μL of air was injected into the reagent inlet and a bubble was formed at the bottom of the reagent chamber, the reference loading method did not fill the device well, while the express loading method did fill the device well. When greater than 1 μL of air was injected into the reagent inlet and bubbles were formed only at the top of the reagent chamber, both the reference loading method and the express loading method filled the device well. However, when greater than 1 μL of air was injected and bubbles were formed at the top and bottom of the reagent chamber, the reference loading method did not fill the device well, while the express loading method did fill the device well.

Thus, whereas the reference loading method only filled the device well when no bubbles were formed or when bubbles were only formed at the top of the reagent chamber, the express loading method of an embodiment of the present invention filled the device well in all of the studied bubble formation conditions.

In summary, experiments conducted for the express loading method according to the present teachings confirmed that express loading method provided several advantages over the reference loading method. More specifically, in comparison with over the reference loading method, the express loading method exhibited a faster overall run time, resulting from: a) a reduced time required for the instrument to load samples and assays into reaction chambers; and b) a reduced time required for mixing of samples and assays on the IFC. Additionally, the express loading method eliminated the need for a separate prime step, and thus eliminated a user interaction between the prime and load/mix steps of the reference loading method, and reduced hands-on time of lab workers. Also, the express loading method reduced sensitivity to bubbling in reagent inlets. Furthermore, the express loading method provided the foregoing advantages while being compatible with all current 96.96 IFCs and without altering existing thermal cycling and detection steps.

The method of the present embodiments, as described above, are applicable to a wide range of microfluidic devices. Further, the methods according to the present teachings for preparing a microfluidic device for use can be implemented in software using known techniques as informed by the present teachings.

Those having ordinary skill in the art will appreciate that various changes can be made to the above embodiments without departing from the scope of the present teachings.

1. In a microfluidic device formed of a perfusable material having a plurality of discrete fluidic networks in communicable distance, the networks comprising elements that trap air during filling, a method for preparing said microfluidic device for operation, comprising sequentially performing the following steps:
(a) introducing a first liquid into a first network to pressurize a first gas in the first network to a pressure greater than a pressure associated with a second network so as to purge a portion of the gas out of the first network while another portion of the first gas remains trapped in at least one region of the first network and is perfused at least partially into said second network,
(b) introducing a second liquid into the second network in fluidic communication with a chamber from which measurements are made so as to pressurize a second gas in second network to a pressure greater than a pressure associated with a third network so as to purge a portion of the second gas out of the second network while another portion of the second gas remains trapped in least one region of the second network and is perfused at least partially into the third network,
(c) introducing a third liquid into a third network to pressurize a third gas in the third network to a pressure greater than a pressure associated with a fourth network so as to purge a portion of the gas out of the third network while another portion of the third gas remains trapped in at least one region of the third network and is perfused at least partially into said fourth network, and
(d) introducing a fourth liquid into the fourth network to purge the third gas out of the fourth network.

2. The method of claim 1, further comprising heating the first liquid.

3. The method of claim 1, wherein said first, said second, and said third gas are the same.

4. The method of claim 1, wherein the networks are connectable through closable interfaces/valves.

5. The method of claim 1, wherein a maximum thickness of the perfusable material between at least one of said networks and an adjacent network is less than a minimum thickness of the perfusable material extending at least one of said networks to an edge of a body of said microfluidic device.

6. The method of claim 1 wherein any of said first, second and third liquid are any of aqueous and organic liquid.

7. The method of claim 6, wherein any of said first, second and third liquid comprise any of water, alcohol and, oil.

8. The method of claim 1, wherein any of said first, second and third gas comprises any of air, nitrogen, oxygen, carbon dioxide, and argon.

9. The method of claim 1, wherein said elements comprise chambers.

10. The method of claim 1, wherein a volume of the trapped gas is any of said steps is greater than a volume of the trapped gas in a subsequent step, if any.

11. The method of claim 1, wherein any of said networks is at least partially filled with a liquid prior to receiving a trapped gas from an adjacent network.

12. The method of claim 11, wherein the trapped gas received by said at least partially filled network flows as bubbles through the liquid partially filling that network.

13. The method of claim 11, wherein the gas received by said at least partially filled network pushes the liquid partially filling that network out of that network.

14. The method of claim 1, wherein the pressure associated with any of said pressurized networks is any of equal to, greater than, or less than atmospheric pressure.

15. In a microfluidic device having a plurality of assay chambers, a plurality of sample chambers, and a microfluidic manifold configured to provide selective coupling between the assay chambers and the sample chambers, said microfluidic manifold comprising a network of interface channels between the assay chambers and the sample chambers and a network of containment channels for isolating each pair of said assay and sample chambers from adjacent pairs, a method for preparing the microfluidic device for operation, comprising sequentially performing the following steps:
(1) pressurizing said interface network via a liquid to a pressure greater than a pressure associated with the sample chambers so as to purge at least a portion of a gas present in the interface network while another portion of the gas remains trapped in at least one region of the interface network and is perfused at least partially into said sample chambers,
(2) pressuring said sample chambers via a liquid to a pressure greater than said assay chambers to purge at least a portion of a gas present in the sample chambers while another portion of the gas remains trapped in at least one region of the sample chambers and is perfused at least partially into said assay chambers,
(3) pressurizing said assay chambers via a liquid to a pressure greater than a pressure associated with said containment network so as to purge at least a portion of a gas present in the assay chambers into said containment network, and
(4) pressurizing the containment network for at least partially purging the containment network.

16. The method of claim 15, wherein the sample chambers are the location from which measurements are made following reaction and/or mixing of a sample with an assay.

17. The method of claim 15, wherein the step (2) causes purging of the sample chambers at least partially through the containment network.

18. The method of claim 15, wherein the step (3) causes venting of the assay chamber at least partially through the containment network.

19. The method of claim 15, wherein the sample chambers are taller than the assay chambers.

20. The method of claim 15, further comprising transitioning the interface network from a closed state to an open state to allow mixing of assays and samples in said assay and sample chambers.

21. The method of claim 20, further comprising raising the temperature of said microfluid device to facilitate said mixing of said assays and samples via diffusion.

22. The method of claim 15, wherein the performance of said sequential steps substantially reduces probability of bubble formation in said sample and assay chambers relative to performing the steps (1), (2), (3) and (4) in claim 14 in the order (1), (4), (3), (2).
